(19) United States
(12) Patent Application Publication
(10) Pub. No.: US 2017/0360535 A1
(43) Pub. Date: Dec. 21, 2017

(54) PRE-FORMS AND METHODS FOR USING SAME IN THE MANUFACTURE OF DENTAL PROSTHESES

(71) Applicant: DENTAL WINGS INC., MONTREAL (CA)

(72) Inventors: MICHAEL RYNERSON, MONTREAL (CA); JEAN-MARC PEROT, MONT-ROYAL (CA); PIERRE-OLIVIER ROY, QUÉBEC (CA)

(21) Appl. No.: 15/538,923

(22) PCT Filed: Dec. 22, 2015
(86) PCT No.: PCT/CA2015/051360

§ 371 Date: Jun. 22, 2017

Related U.S. Application Data
(60) Provisional application No. 62/095,250, filed on Dec. 22, 2014.

(51) Int. Cl. A61C 13/00; A61C 5/77; A61C 5/20; G05B 19/4099; A61C 13/20

(52) U.S. Cl. CPC A61C 13/0022; A61C 13/0019; G05B 19/4099; A61C 13/20; A61C 5/20; A61C 13/0004; A61C 5/77; G05B 2219/49023

(57) ABSTRACT

A method for manufacturing a dental restoration pre-form for use in a making a dental prosthesis is disclosed comprising providing a design of the prosthesis and a protocol for manufacturing the prosthesis and producing a dental restoration material pre-form having three dimensional (3D) characteristics based on said design of the prosthesis and steps of the protocol. There is also disclosed a method for manufacturing a dental prosthesis comprising providing dental restoration material pre-form having an associated 3D digital map, the 3D map comprising information on a spatial distribution of characteristics of the pre-form; and processing the pre-form according to a processing protocol the protocol based on a design of the prosthesis and the 3D map of the pre-form. Additionally, there is provided a system for manufacturing dental prosthesis comprising: a pre-form production unit, a pre-form processing unit, and a processor operationally coupled to the pre-form processing unit to execute a processing of the pre-form based on a selected processing protocol.

### TECHNICAL FIELD

This invention relates generally to the manufacture of dental prostheses. More specifically, this invention relates to the processing of dental restoration materials in the manufacture of dental prostheses.

### BACKGROUND TO THE INVENTION

Dental restorations such as inlays, onlays, crowns, bridges, abutments, veneers, implants and the like are now manufactured using digitized processes that include dental impression, design, and manufacturing techniques such as Computer Numerically Controlled (CNC) milling, 3D printing, or laser milling for example. Typically the digital production of a dental restoration is performed on a “block” or “disk” of material to mill out the final prosthetic shape based on a 3D model, which can be further processed to achieve desired texture, color, translucency, and the like. Despite the advances in dental materials processing, there are increasing expectations from patients for dental restorations with superior aesthetics and durability, at more affordable prices.

Currently available dental restoration production technologies have significant limitations in production rate, accuracy, resolution, and ability to process common dental materials, particularly but not limited to materials exhibiting high hardness, brittleness, and low fracture toughness. Furthermore, currently available dental material processing methods can adversely affect the prosthetic during processing, potentially resulting in sub-optimal finished product characteristics and performance.

There is therefore a need for more effective dental restoration manufacturing process.

### SUMMARY OF THE INVENTION

In an aspect there is provided a method for manufacturing a dental restoration pre-form for subsequent use in making one of a plurality of different dental prosthesis. The method comprises identifying common three (3D) characteristics of the plurality of different dental prosthesis, and producing the dental restoration material pre-form comprising the common 3D characteristics.

In another aspect there is provided a method for manufacturing a dental prosthesis having a design and a protocol for manufacturing the prosthesis based on the design. The method comprises providing a plurality of different dental pre-forms each comprising an associated 3D digital map comprising information on a spatial distribution of characteristics of the pre-form wherein the characteristics are common a plurality of different dental prosthesis, selecting one of the plurality of different dental pre-forms based on a comparison of the spatial distribution of characteristics with the design of the prosthesis, the protocol for manufacturing the prosthesis or combinations thereof, and processing the selected pre-form according to the protocol and the 3D map of the pre-form.

In a further aspect there is provided a composition of dental material for manufacturing a plurality of different dental prostheses. The composition comprises a pre-form structure having a geometry substantially similar to the plurality of different dental prostheses and comprising fiducial markers for identifying regions of the pre-form structure.

In another aspect there is provided a system for manufacturing dental prostheses. The system comprises a dental pre-form selected from a plurality of different pre-forms, each of the different pre-forms comprising characteristics common to a plurality of different dental prostheses, a pre-form processing unit, and a processor operationally coupled to the pre-form processing unit to execute a processing of the selected pre-form based on a selected processing protocol.

In a further aspect there is provided a method for manufacturing a dental restoration pre-form for use in a making a dental prosthesis comprising providing a design of the prosthesis and a protocol for manufacturing the prosthesis and producing a dental restoration material pre-form having three dimensional (3D) characteristics based on the design of the prosthesis and steps of the protocol.

In another aspect of the invention there is provided a method for manufacturing a dental prosthesis comprising providing dental restoration material pre-form having an associated 3D digital map, the 3D map comprising information on a spatial distribution of characteristics of the pre-form, and processing the pre-form according to a processing protocol the protocol based on a design of the prosthesis and the 3D map of the pre-form.

In a further aspect of the invention there is provided a system for manufacturing dental prosthesis comprising: a pre-form production unit, a pre-form processing unit, and a processor operationally coupled to the pre-form processing unit to execute a processing of the pre-form based on a selected processing protocol.

### BRIEF DESCRIPTION OF THE DRAWINGS

The invention will be better understood by way of the following detailed description of embodiments of the invention with reference to the appended drawings, in which:

FIG. 1 is a flow chart diagram of a method for manufacturing a dental prosthesis according to an embodiment of the invention;

FIG. 2 is a flowchart of an example of method for selecting and processing a pre-form;

FIG. 3 is a schematic diagram of a system of the invention for manufacturing prostheses using pre-forms;

FIG. 4 is a schematic diagram of a system of the invention for processing pre-forms;

FIG. 5 is a flowchart of an example of method for designing a pre-form;

FIG. 6A shows a top plan view of a pre-form that is essentially the final prosthesis geometry in an embodiment without surface details;

FIG. 6B shows a top plan view of a pre-form that is essentially the final prosthesis geometry in an embodiment with cusps and fissures;

FIG. 7A shows a raised perspective view of a pre-form that has a shape marginally bigger than a final prosthesis design shown in FIG. 7B;

FIG. 7B shows a raised perspective view of the final prosthesis to be manufactured from pre-form shown in FIG. 7A;

FIG. 8A shows a sectional view of a pre-form external geometry that is conforming to the final prosthesis design but does not have the internal space to fit over a tooth stump as shown in the final prosthesis in FIG. 8B;

FIG. 8B shows a sectional view of a prosthesis to be manufactured from pre-form shown in FIG. 8A;

FIG. 9A shows a top plan view of another embodiment of pre-forms represented by dotted line and having a thin and long shape specifically constructed for placement of one or multiple thin prosthesis such as veneer shown in solid line; and

FIG. 9B shows a side plan view of pre-forms represented by dotted line and having a thin and long shape specifically constructed for placement of one or multiple thin prosthesis such as veneer shown in solid line.

### DETAILED DESCRIPTION OF THE ILLUSTRATIVE EMBODIMENTS

In one aspect of the invention there is provided dental restoration material preforms. By pre-form it is meant a dental restoration material or materials, used to make a particular restoration (prosthesis), i.e. during an initial or intermediate stage of manufacturing. Thus the design and manufacture of pre-forms can be considered as the initial or intermediate step in a dental production center, dental laboratory, or dental office manufacturing process in which material is removed (example: cutting the general shape from a block), added (example: molding a block or disk, or addition of material to an existing mandrel), and/or processed (example: creation of cosmetic details in an existing block, disk, or other shape). These additive, transformative and/or removal steps can be applied successively to create a multi-layer/material or volumetrically heterogeneous material with 3D location specific material composition throughout the volume of the pre-form. The shape and composition of the pre-form at a particular stage can be a function of the subsequent steps required by a particular design or process to achieve the desired end aesthetics and function of the prosthesis.

The pre-forms are designed to accommodate and potentially optimize subsequent manufacturing processes and/or optimize the shape, composition, aesthetics, and functionality of the restoration.

While a pre-form may be defined by a few general characteristics such as its material composition, translucency, color, and geometry, it is also possible to provide a 3D digital map that corresponds to the spatial configuration of the pre-form and information about the characteristics of the pre-form in corresponding voxels.

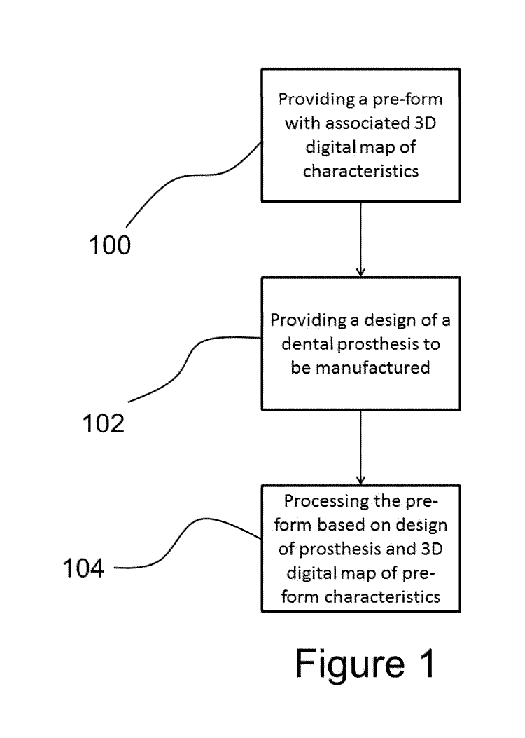

Thus in an embodiment and with reference to FIG. 1 there is provided a method for manufacturing a dental prosthesis comprising providing (100) a pre-form having an associated 3D map comprising information on the spatial distributions of characteristics of the pre-form, providing (102) a design of the prosthesis and processing (104) the pre-form according to a design of the prosthesis. By characteristics of the pre-forms it is meant parameters such as dimensions, type of material, physico-chemical properties and the like.

The 3D map of the characteristics of the pre-form may already be known or may be acquired by digital scanning for example by using an optical head or by otherwise acquiring information on the properties of the pre-form.

Pre-forms that are to be used for a particular type of restoration can be designed based on the desired characteristics of that restoration. While each restoration calls for a unique processing of the restoration material to fit the needs of a patient, certain types of restoration share common characteristics such that a pre-form with “average” characteristics can be designed. The pre-form comprising these common characteristics can then be processed according to a protocol that is adapted for the dental restoration of a specific patient. To that effect the restoration can be designed and, preferably a 3D digital map of the characteristics of the restoration is generated based on the design. A processing protocol can then be determined based on the design of the prosthesis and the characteristics of the selected pre-form.

A design of the prosthesis can be performed using known methods and technologies such as by obtaining a dental impression and scanning the impression or by performing an intra-oral scan or 3D X-ray. The design also preferably comprises, in addition to the 3D geometric information of the restoration, information on the physicochemical properties of the final restoration. By physico-chemical properties it is meant shades, translucency, texture, hardness and the like. This information may then be stored in a 3D digital map of characteristics of the restoration. The information on the design can then be used to dictate the steps involved in selecting and processing the pre-form(s).

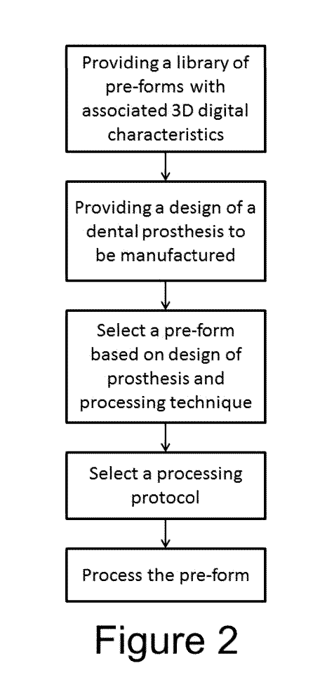

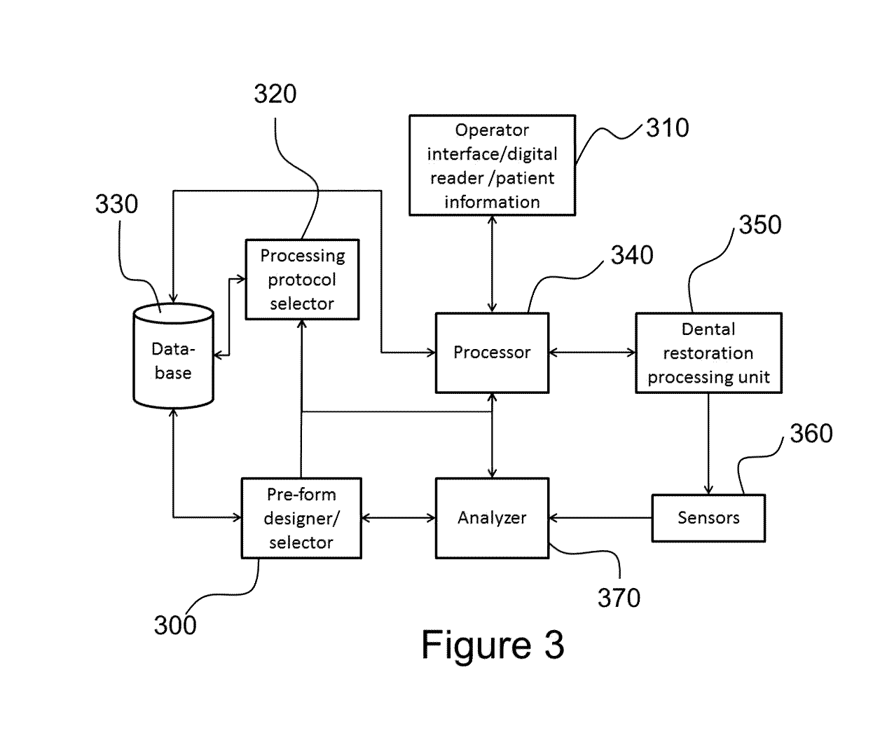

In an embodiment of the invention a library of pre-forms is provided from which pre-forms will be selected to be used for dental restorations as described in the flow chart of FIG. 2. The library comprises a plurality of pre-forms having different characteristics. The pre-forms in the library may have identification fields associated therewith so that the pre-forms may be identified, for example, by their characteristics and/or by the compatibility for a particular processing method. Thus once the design of the final prosthesis is made the optimal pre-form can be selected from the library based on its identification.

The 3D map of the restoration may be compared to 3D maps of characteristics of pre-forms in the library and the best pre-form selected according to a set of selection rules. An example of a selection rule may be “select pre-form with closest shade”. It will be appreciated that there may be more than one selection rule and the rules may apply to any or all of the characteristics stored in the 3D maps of characteristics.

In another embodiment of the invention a unique pre-form could be designed and produced for a particular individual restoration. This unique pre-form could include specific material, geometry, color, shade, translucency, and other characteristics that are in part or completely unique to an individual indication for an individual patient. The unique characteristics can be varied voxel by voxel throughout the pre-form.

Once a pre-form has been selected a processing protocol is in turn selected. The selection of the protocol may be pre-determined by the selection of a pre-form. That is to say each pre-form may have associated to it a processing protocol that is automatically activated upon selection of the pre-form. The processing protocol may also be elaborated based on the desired characteristics of the prosthesis. Thus once a pre-form has been selected based on one or more selection rules a comparison of the characteristics of the pre-form with those for the desired prosthesis is performed that will generate the processing steps required to obtained the prosthesis from the selected pre-form. The comparison may be made for example by comparing the 3D digital maps of characteristics of the pre-form and the designed prosthesis.

Processing of dental restoration materials is typically performed in a series of steps during which some of the material is removed, added, or treated to achieve a desired effect such as a different texture, different crystalline structure, different color, or a different shape. Each of these steps can result in either bulk or local modifications of the material such that subsequent steps in the regions of the modification may be rendered difficult to optimize. Thus it may be advantageous to design pre-forms to take into account the modifications that will take place during subsequent processing operations. For example a pre-form can be manufactured that exhibits spatially heterogeneous characteristics. Thus the pre-form may be manufactured with two (or more) materials or a single material in two or more states. In a non-limiting example of a pre-form for a veneer, it may comprise a front section made of (or having a higher content) a material that lends itself to better polishing and/or shading if the front surface will be visible in-situ. The back of the pre-form would perhaps contain less of this particular material. In a further example, the amount of the material may be “graded” so as to provide gradation in shading along a surface of a restoration. Other characteristics of the pre-form may also be designed as a function of the desired prosthesis (thickness, surface finish to promote adhesion, variations in translucency, and other effects).

In another aspect of the invention the pre-form may comprise fiducial markers for the precise positioning of the pre-form within a processing unit. The fiducial markers may also be registered with the 3D map of characteristics of a pre-form to provide reference points for the processing. But it will be appreciated that the spatial positioning may also be achieved by scanning the perform for example to obtain coordinates that can be related to the 3D map of the pre-form.

In another aspect of the invention there is provided a system for designing, selecting, and/or processing pre-forms. The system comprises a pre-form designer/selector 300. Inputs may be received from a user interface 310 or from a digital reading of identification information on the dental material or the file of the patient or any other information identifier. The information provided to the pre-form designer/selector comprises information regarding the desired characteristics of the prosthesis. The system may further comprise a processing protocol selector 320 which may select a protocol based on information from the pre-form designer/selector or the database. The database 330 may comprise a library of pre-forms and, preferably a library of 3D digital maps of characteristics of pre-forms. The processor 340 can implement the selected processing protocol in the processing unit 350 as well as communicating with database 330, processing protocol selector 320, pre-form designer/selector 300, operator interface 310 and analyzer 370. In a completely automated system the processor can also control an actuator to physically locate and manipulate a pre-form to position it within the processing unit. Sensors 360 such as a camera may also be provided to detected fiducial markers on the pre-form and relay the information to an analyzer 370 for further processing of this positional information.

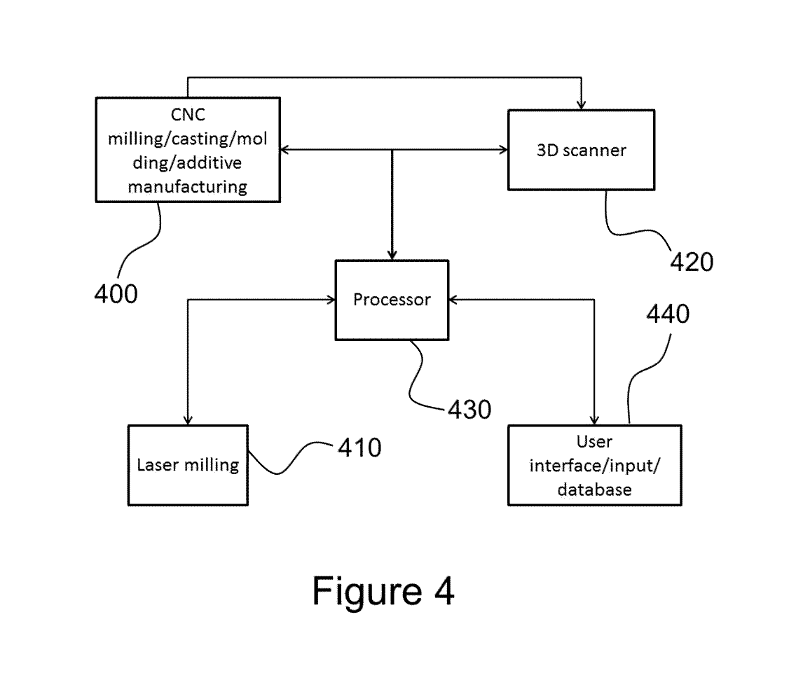

In another embodiment there is provided a system (FIG. 4) that combines traditional CNC milling, casting, molding, or additive manufacturing 400 to produce a pre-form from a starting material (for example a block of material) and a laser milling unit 410 to process the pre-form into a finished prosthesis. The system may comprise a 3D scanner 420 to acquire information on the geometry (shape) of the pre-form as well as other characteristics of the pre-form. This information may then be used in the laser milling unit to process the pre-form according to a pre-determined design or according to parameters provided to the processor by a practitioner (dentist or lab technician) at 440. The various components of the system can be controlled by processor 430. In such a system the laser milling unit performs specific processing tasks on the pre-form such as but not limited to high resolution cusps and fissures, surface treatment or texturing of the restoration (bonding surface), glazing, and coloring.

It will be appreciated that the system may comprise two or more units or modules, for preform production and for preform finishing via laser milling. The 3D scanner may also constitute a separate unit or module. Alternatively the treatment of the material from the starting material to the finished prosthesis may remain in the same unit comprising all the components (e.g. CNC milling, 3D scanner, laser milling) to process the material. Thus the system may be an all in one in which the pre-forms are created within a single unit or may comprise separate units or modules.

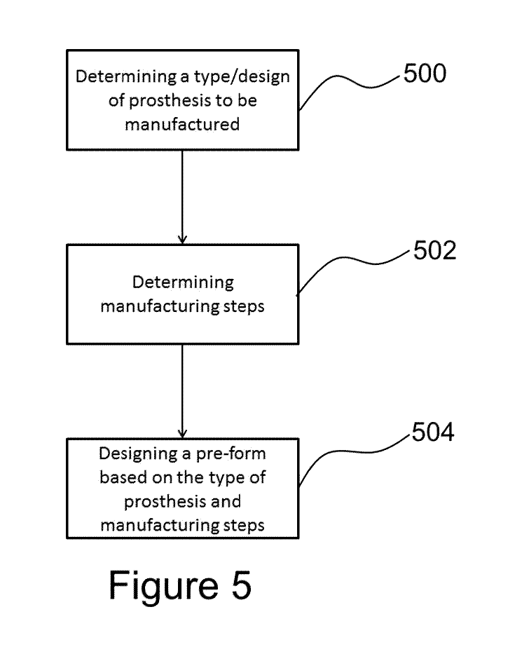

As mentioned above a pre-form or a series of pre-forms may be manufactured that have basic standard characteristics that lend themselves to finishing the prosthesis based on a design of the prosthesis. Thus with reference to FIG. 5 the design of a preform 504 can be based on the desired characteristics of the prosthesis to be manufactured 500 as well as the manufacturing steps involved in the processing of the pre-form 502.

For example, in the case of a crown, a basic structure for each tooth can be produced in serial production of “standard” pre-form crowns. The finishing of the crown can be performed chair-side at the dentist office using for example a traditional CNC milling system or a laser milling system. In such cases a 3D X-ray, impression scan, or an intra-oral scan from the patient can be acquired at the dentist and the information about the design of the prosthesis provided to the laser milling unit for processing a selected pre-form into the final prosthesis. The benefits of laser milling for this approach may include process speed, processing materials in a hardened state, creation of small details, creation of thin structures, geometric precision accuracy and resolution, reducing variability, and creation of surface finish such as polishing or processing to optimize functional aspects of the prosthesis. The 3D scanner capability allows the alignment of the pre-form (intermediate restoration processing step) so that the laser milling unit can subsequently apply the desired treatment.

For example, the pre-form could have the approximate shape of an anterior or posterior crown or veneer. Removal of an amount of material representing the difference between the shape of the preform and that of the final desired restoration could be done more quickly than starting from a larger rectilinear block, disk, or other geometric shape. This approach could be efficient enough to enable the use of hardened materials such as fully sintered Zirconia chairside allowing the finishing step to be performed quickly while the patient is waiting in the dental office.

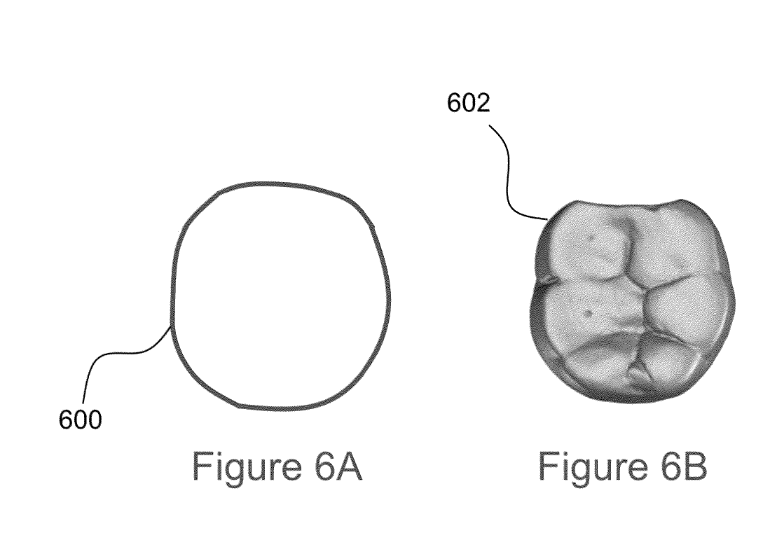

FIGS. 6 to 9 provides a schematic view of a pre-form for a crown. The dental material pre-forms of the present invention advantageously reduce the amount of starting material required to process the material into its final shape.

The pre-forms may be provided embedded in sacrificial material to provide easy storage of manipulation prior to processing. The sacrificial material may be a material that is different from that of the pre-form and easily removed using known techniques (milling, laser ablation). A pre-form embedded or partly embedded in a sacrificial material may represent a unit and in some embodiments several units may be joined together. These joined together units may facilitate serial production of similar restoration.

The pre-forms preferably comprise at least one attachment structure to provide a means to secure and position the pre-forms within a processing unit without impeding the interaction of the various processing elements with the pre-form. For example a crown pre-form could have an attachment structure on the external surface to allow attachment or fixing to a support member within a processing unit.

The pre-forms of the invention may be made of a single material or may be comprised of a combination of materials. As will be further described below, pre-forms made of a combination of materials offer several advantages for more precise and efficient processing. The manufacturing of multi-material pre-forms may rely on known composite material production methods. Types of materials that can be used include but are not limited to ceramic, polymer, metal, glass ceramic, polymer matrix including ceramic or glass ceramic particles, or any of a range of materials commonly known as porcelains. The pre-forms are available in several shade, translucency and size.

Furthermore the pre-form may comprise material in an intermediate (transition) phase state that could be an uncrystallized state or pre-sintered material for example.

### EXAMPLES

The following example constitutes a non-limiting exemplary embodiment of the method(s) of the invention.

After performing the digital design of the restoration, the user selects the desired restoration digital file to be produced by the laser milling machine.

The user identifies which type of material and what type of blank to use for the restoration manufacturing (pre-form, small block, large block, disk, multi element support, bar, rod, etc.).

The user or material handling system inserts the identified pre-form and the user initiates the machining process.

The laser milling machine scans the pre-form and confirms the pre-form choice.

The laser milling machine positions the pre-form and continues the laser ablation process until the final shape is achieved.

FIGS. 6A, 6B, 7A, 7B, 8A, 8B, 9A and 9B provide examples of pre-forms. FIG. 6A and 6B show a pre-form that is essentially the final prosthesis geometry. FIG. 6A shows an embodiment without surface 600 and FIG. 6B shows an embodiment with cusps and fissures 602.

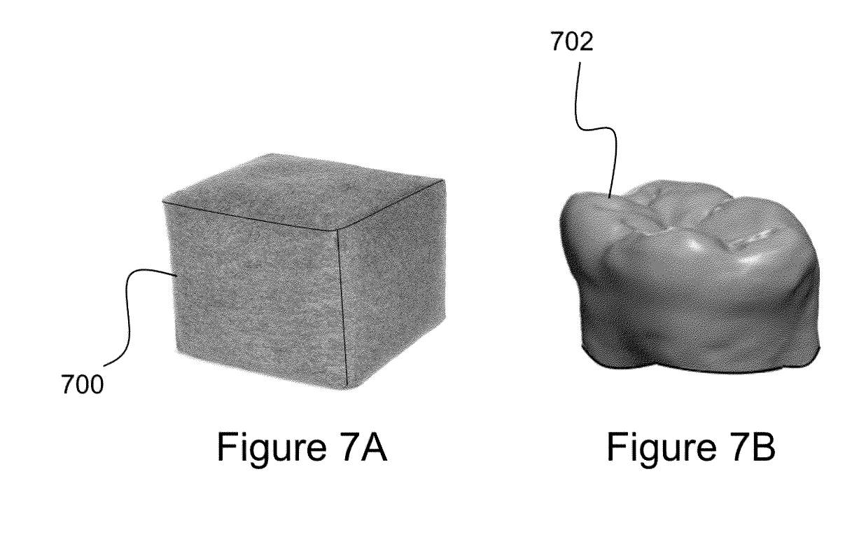

FIG. 7A shows a pre-form 700 that has a shape marginally bigger than the final prosthesis design 702 shown in FIG. 7B.

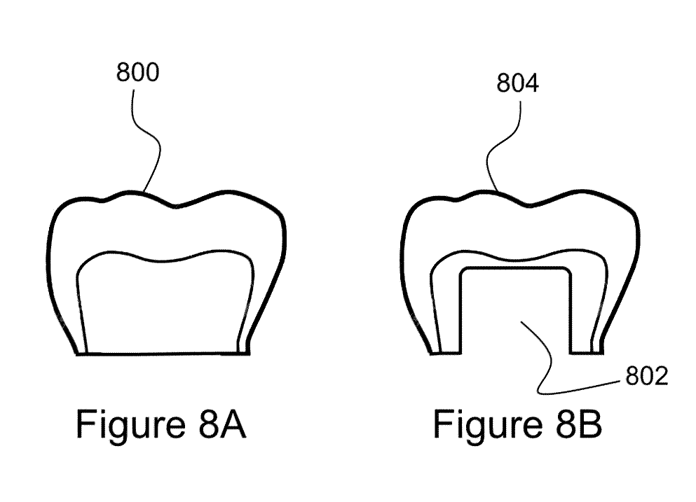

FIG. 8A shows a pre-form external geometry 800 that is conforming to the final prosthesis design but does not have the internal space 802 to fit over a tooth stump as shown in the final prosthesis in FIG. 8B. The final prosthesis 804 is manufactured from the pre-form according to the embodiments of the present invention.

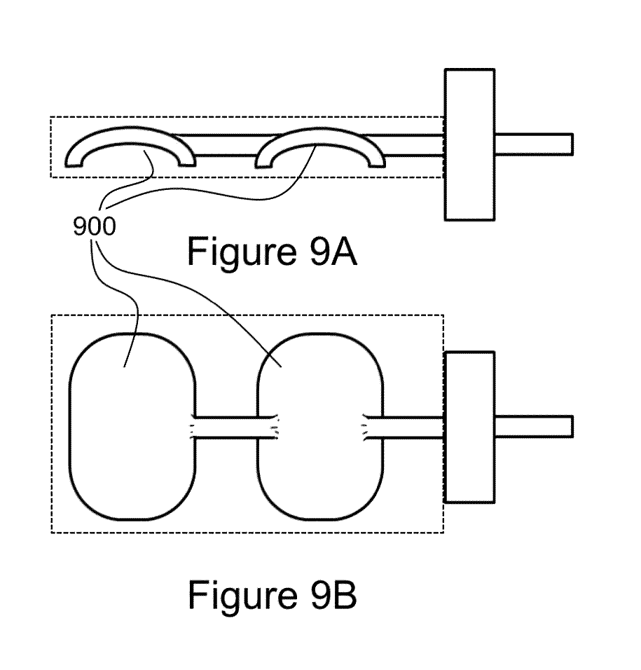

In FIGS. 9A and 9B show pre-forms 900 represented by dotted line and having a thin and long shape specifically constructed for placement of one or multiple thin prosthesis such as veneer shown in solid line.

Although the present invention has been described hereinabove by way of specific embodiments thereof, it can be modified, without departing from the spirit and nature of the subject invention as defined in the appended claims.

1. A method for manufacturing a dental restoration pre-form for subsequent use in making one of a plurality of different dental prosthesis, the method comprising:
identifying common three (3D) characteristics of the plurality of different dental prosthesis; and
producing the dental restoration material pre-form comprising said common 3D characteristics.

2. The method of claim 1, wherein said producing comprises machining, molding, casting, additively manufacturing and combinations thereof, a dental material into said pre-form.

3. (canceled)

4. (canceled)

5. The method of claim 1, wherein said common 3D characteristics are based on average characteristics of the prosthesis across a range of patients.

6. The method of claim 1, wherein said pre-form is designed with characteristics specific to a unique patient and wherein said characteristics of said pre-form comprise one or more of geometry, strength, hardness, texture, type of material, material gradient, property gradient, shade, color, translucency and surface finish.

7. (canceled)

8. The method of claim 1, wherein said providing a design of said prosthesis comprises acquiring a 3D model of a dental structure to be replaced and deriving a pre-form shape based on said 3D model wherein said acquiring comprises scanning a dental impression or a dental model or performing an intra-oral scan or an x-ray scan.

9. (canceled)

10. (canceled)

11. The method of claim 1, wherein the prosthesis is selected from a dental veneer, a crown, a coping, a bridge, an inlay, an inlay, an abutment and an implant.

12. The method of claim 1, wherein said pre-form comprises dental restoration material in an intermediate (transition) state and wherein said intermediate state is selected from uncrystallized and pre-sintered material.

13. (canceled)

14. (canceled)

15. The method of claim 1, wherein said prosthesis has heterogeneous structural properties and said step of producing comprises a plurality of predetermined steps to produce intermediate phase pre-forms in accordance to said heterogeneous structural properties.

16. A method for manufacturing a dental prosthesis having a design and a protocol for manufacturing the prosthesis based on the design, comprising:
providing a plurality of different dental pre-forms each comprising an associated 3D digital map comprising information on a spatial distribution of characteristics of said pre-form wherein said characteristics are common a plurality of different dental prosthesis;
selecting one of said plurality of different dental pre-forms based on a comparison of said spatial distribution of characteristics with the design of the prosthesis, the protocol for manufacturing the prosthesis or combinations thereof; and
processing said selected pre-form according to the protocol and said 3D map of said pre-form.

17. The method of claim 16, wherein said providing a plurality of different pre-forms comprises providing a library of pre-forms and the method further comprises selecting a preform based on said design of the prosthesis and said 3D map of characteristics of the pre-form.

18. The method of claim 17, wherein said selecting a pre-form comprises comparing a 3D digital map of characteristics of the design of the prosthesis with the 3D digital map of desired characteristics of a pre-form.

19. (canceled)

20. (canceled)

21. (canceled)

22. (canceled)

23. (canceled)

24. A composition of dental material for manufacturing a plurality of different dental prostheses, comprising:
a pre-form structure having a geometry substantially similar to the plurality of different dental prostheses and comprising fiducial markers for identifying regions of said pre-form structure.

25. The composition of claim 24, wherein said pre-form structure further comprises one or more attachment structures on said pre-form structure to position the pre-form structure in a processing unit.

26. The composition of claim 24, wherein said pre-form structure comprises two or more types of material.

27. The composition of claim 24, wherein said pre-form structure comprises two or more states of material.

28. The composition of claim 24, wherein said pre-form structure is surrounded by sacrificial support material.

29. A system for manufacturing dental prostheses comprising:
a dental pre-form selected from a plurality of different pre-forms, each of said different pre-forms comprising characteristics common to a plurality of different dental prostheses;
a pre-form processing unit, and
a processor operationally coupled to said pre-form processing unit to execute a processing of said selected pre-form based on a selected processing protocol.

30. The system of claim 29, further comprising a pre-form producing unit.

31. The system of claim 29, further comprising a database comprising a library of said different pre-forms.

32. The system of claim 29, further comprising a preform selector.

33. The system of claim 29, wherein the system further comprises an input interface for providing processing information and wherein said processing information comprises information selected from characteristics of a prosthesis to be manufactured, characteristics of a pre-form, patient information, dental impression, dental scan, x-ray and combination thereof.

34. (canceled)

35. The system of claim 29, wherein said selected pre-form is a customized pre-form.

36. The system of claim 29, wherein the system further comprises sensors for detecting fiducial markers on said selected pre-form and analyzer for relaying positional information to the processor.

37. The system of claim 29, wherein the system further comprises a 3D scanner for scanning a geometry of said selected preform.

38-74. (canceled)
